(19) United States
(12) Patent Application Publication
(10) Pub. No.: US 2013/0080323 A1
(43) Pub. Date: Mar. 28, 2013

(54) RESTRICTED FUNDING SOURCE

(71) Applicant: German Carlos Scipioni, San Jose, CA (US)

(72) Inventor: German Carlos Scipioni, San Jose, CA (US)

(73) Assignee: EBAY, INC., San Jose, CA (US)

(21) Appl. No.: 13/245,570

(22) Filed: Sep. 26, 2011

(51) Int. Cl. G06Q 40/00

(52) U.S. Cl. 705/44

(57) ABSTRACT

An account with restricted use is maintained by a payment provider, where funds from the account can only be used when specific user-determined conditions are met. The user may specify one or more payees, an amount or maximum payment, a time or date range for payment, or other restrictions.

### BACKGROUND

1. Technical Field

The present disclosure generally relates to funding sources, and more particularly to funding sources having restricted use.

2. Related Art

When people or businesses pay for services or goods, they typically pay using a funding source as opposed to cash. Examples of funding sources include banks, credit card companies, and on-line payment providers, such as PayPal, Inc. of San Jose, Calif. Funding sources can also be more specific, such as a checking account at a bank, a savings account at a bank, a Visa credit card, an American Express credit card, etc. These non-cash funding sources enable the user to more easily manage and make payments. For example, the user may set up one savings account to save for a purchase, and the user may set up automatic payments from a checking account for recurring bills, such as utilities, credit card payments, and housing payments.

However, with the ever-increasing problem of identity theft and theft of sensitive information, an unauthorized user may be able to access one or more of a user's funding sources and withdraw funds from those sources. If a comprised funding source was one used to pay recurring bills, there may be insufficient funds to make the payment. As a result, the user may experience consequences of a missed or delayed payment, such as a penalty charge, a late fee, or even a stoppage of a utility or service.

Therefore, a need exists for funding sources that overcome the disadvantages of conventional funding sources described above.

### SUMMARY

In one embodiment, an account with restricted use (also referred to as a restricted use account/funding source, a secure account/funding source, a specific use account/funding source, a limited use account/funding source, or the like) is maintained by a payment provider, where funds from the account can only be used for specific payees. The user may place alternative or additional restrictions on the use of the account. Examples of allowed use include mortgage payments, utility payments, credit card payments, and other recurring “important” payments. The user may specify one or more payees, an amount or maximum payment, a time or date range for payment, or other restrictions. If an attempt is made to withdraw funds from the account that is not allowed by the user, the funds may still be withdrawn, but withdrawal will need specific user approval. For example, the user may be called to confirm the withdrawal amount and payee, the user may be asked to enter a password/PIN and/or answer security questions.

In another embodiment, the account is restricted in how it can be funded. In one example, only direct deposit funds can be deposited into the account. If funds from other sources, such as cash deposits, check deposits, transfers from other accounts/institutions, etc., are desired, the user may be asked to approve such a deposit before the deposit is finalized.

As a result, a user is ensured that important payments are made because the funding source for such payments have been restricted by the user such that only certain payments and conditions will allow payments to be made from the funding source or account. Thus, even if the user's other accounts are compromised, the restricted use account is still secure and protected, enabling continued payments from the account.

These and other features and advantages of the present disclosure will be more readily apparent from the detailed description of the embodiments set forth below taken in conjunction with the accompanying figures.

### BRIEF DESCRIPTION OF THE DRAWINGS

FIG. 1 is a flowchart illustrating a method for a user to set up a restricted use account with a payment provider, according to one embodiment;

FIG. 2 is a flowchart illustrating a method for a payment provider to determine whether funds can be properly withdrawn from (or deposited into) the restricted use account, according to one embodiment;

FIG. 3 is a block diagram of a networked system used in the payment system described above according to one embodiment; and

FIG. 4 is a block diagram of a computer system suitable for implementing one or more devices described herein.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to one embodiment, a system and method are provided for allowing a user to maintain a secure or restricted use account with a payment provider that allows the account to make only certain payments to certain payees, as designated by the user. Non-authorized uses of the account would require a specific user authorization or consent. Thus, the user may have two or more accounts with a payment provider, one or more of which would be a conventional account where the user can freely deposit and withdraw funds for payment and one or more of which would be restricted use accounts where the account can be used for only specific uses, such as specific payees, specific deposits, specific limits, etc. As a result, even if the user's accounts are compromised, e.g., the conventional accounts are fraudulently depleted because someone has obtained account and user information, important payments can still be made with the restricted use account since funds cannot be generally withdrawn.

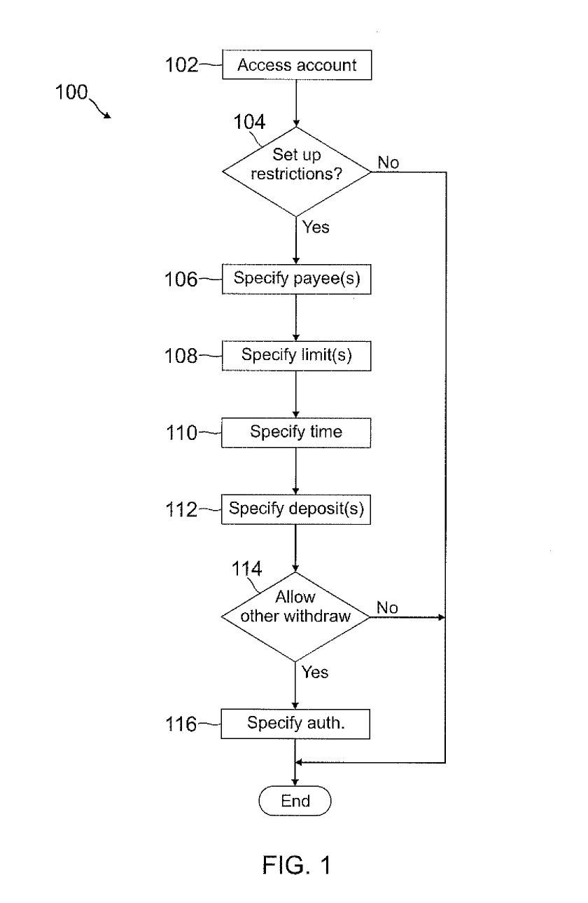

FIG. 1 is a flowchart illustrating a method 100 for a user to set up a restricted use account with a payment provider, such as PayPal, Inc. of San Jose, Calif., according to one embodiment. At step 102, the user accesses a user account with the payment provider. Access may be through any computing device, such as a smart phone, a PC, a tablet, a desk top computer, etc. Access may also be through voice, such as an interactive voice recognition (IVR) system or a call to the payment provider. Information is communicated, based on the type of access, to the payment provider. In one embodiment, the information includes a user identifier, such as a user name, email address, or phone number, and a password or PIN. In another embodiment, security questions/answers or other information to enable the payment provider to identify and/or authenticate the user and locate a corresponding account may be used. If the user does not have an account with the payment provider (or has an account that needs updating), the user may be asked to create an account or update requested information before continuing.

Once the user has accessed or created an account, the user may see an option to set up a new restricted use account. This may appear on a user home page as a tab, link, button, or other indicator, displayed on a user device. If the user decides to set up the restricted use account, as determined at step 104, the user selects, clicks, or taps on the appropriate tab, link, or button, which communicates appropriate information to the payment provider.

The payment provider, in response, may present the user a screen requesting the user to enter various restrictions of use and other parameters for the account. For example, the user may first be asked to provide, at step 106, one or more payees as the only recipients allowed to receive funds from the account. In one embodiment, the payees are ones that need to receive funds by a certain date. Examples include companies or entities who have loaned money or extended credit to the user, such as a bank, a credit card company, or a mortgage company, utility companies, such as gas, electricity, and water, service companies, such as phone, cable, and satellite, and home/building owners where the user is required to pay rent to use the home, dwelling, apartment, or building.

Specification of payees may include identifying an account number associated with payment, such as an account number of the payee or of the user, phone number of the payee, address of the payee, the name of the payee, etc. This allows the user to control who is able to obtain funds from the account. Thus, only “important” payees may be included to ensure they receive payments. If the user does not specify himself/herself as a payee, then even if the user's identity/account is compromised, funds will not be given to someone impersonating the user.

The user may also be asked to specify, at step 108, any desired limits for the account. Limits may include a per transaction limit amount, a total amount limit for a given time, such as from the beginning to the end of the month or from one pay period to the next pay period, specific limits for specific payees, amount limits based on the day or dates, and/or a limit as to the number of withdrawals that can be made from the account over a specified period of time. For example, if a designated payee is a bank for mortgage payments or a credit card company for monthly payments, the user may specify that payments made to the payee cannot exceed $X of the minimum payment, only one payment per month is allowed, etc. This provides additional protection of how funds in the account are used to further ensure payments are only made to specific payees during specific times. As a result, even if someone was able to “trick” the payment provider into believing it was a specified payee, at most only a certain amount may be taken out, thereby limiting exposure.

Next, at step 110, the user may specify time restrictions for account usage. In different embodiments, the use may specify how long payments to a specific payee can be paid, when payments can be made to a specific payee, i.e., within a certain time frame or window, an end date for recurring payments, etc. For example, for the mortgage/credit card payment, a payment from the account can only be paid no more than five business days before the due date, can only be paid on the day before the due date, the payment, if a mortgage, ends by a certain year where the mortgage is expected to be paid off, etc. Time restrictions are yet another way for the user to make the account more secure and reduce overall risk of the account being fraudulently depleted.

In addition to restrictions on funds being withdrawn from the account, the user may also specify or place restrictions as to how funds enter the account. For example, only direct deposits may be accepted as a funding source, a linked account with the same payment provider or other funding source may be automatically used to fund the account if the account balance drops below a certain minimum amount, only deposits on certain days will be accepted, etc. By placing even deposit restrictions, the user can limit the number of ways the account can be accessed, even if it is for depositing funds. The more an account is accessed, the more potential risk of someone being able to improperly access funds to withdraw.

Note that the above steps may be combined or performed in any sequence, as well as deleted. Additional limitations may also be added. Also, restrictions can be combined with a certain step. For example, when a user specifies a payee, other restrictions to the payee may be set before specifying the next payee.

Once the user is finished setting restrictions and limitations on the account, the user may be asked, at step 114, whether the user wishes to allow the account to be used outside these restrictions and limitations. If yes, the user may specify the details at step 116. For example, the user may request to be contacted by text, email, and/or phone call any time a request for withdrawal from the account is made that is outside the specified use and limitations. The user will have to be confirmed before authorization can be made and the funds used from the account. In one embodiment, the user will be asked to provide a PIN or password, which may be the same or different from the original account access. In one embodiment, the password is different so that even if the original account was compromised, there is an additional layer of security to access the restricted use account. The user may also be asked one or more security questions to authenticate the user.

Additional authorization conditions/requirements may be based on the reasons the withdrawal was not approved. For example, if a withdrawal request greatly exceeds a specified amount limit, the user may be required to authenticate with multiple factors. However, the user may specify that if a withdrawal request is $10 over a specified limit, the payment provider must notify the user, but can proceed with payment if no confirmation is received within a certain time frame, or the user can confirm with a simple text reply. Thus, the user may specify different levels of authorization for different conditions.

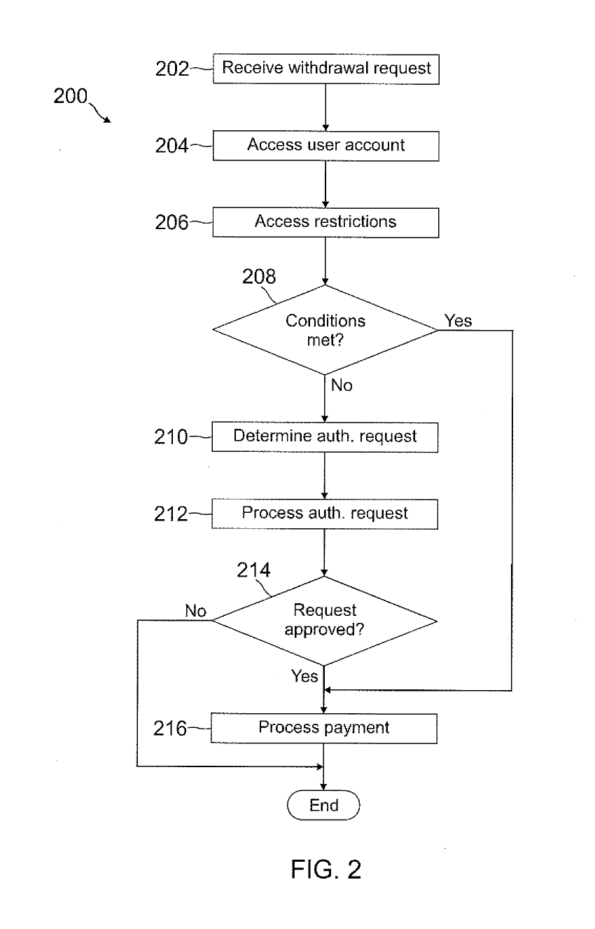

FIG. 2 is a flowchart illustrating a method 200 for a payment provider to determine whether funds can be properly withdrawn from (or deposited into) the restricted use account, according to one embodiment. At step 202, the payment provider receives a request to withdraw funds from the restricted use account. The request may be received when a potential payee attempts to withdraw funds from the account. The request may include the identity of the potential payee, account information of the potential payee, the requested withdrawal amount, and an identifier of the user account.

Once the withdrawal request is received, the payment provider accesses the user account associated with the withdrawal request at step 204. The withdrawal request may include a user name, account number, phone number, or email address. The payment provider determines whether an account exists corresponding to the received information. If no account exists, the request is denied. However, if an account exists, the payment provider accesses, at step 206, restrictions and/or limitations associated with the account. Such restrictions may include the one or more restrictions described above in FIG. 1, alone or in combination with other restrictions.

Next, at step 208, the payment provider determines whether the request for withdrawal received at step 202 meets the conditions for the account use, such as by determining whether there are restrictions that apply to the request and then whether the restrictions are met. For example, the request may come from a certain payee, for a certain amount, on a certain date. The account may restrict use to specific payees, up to or at a certain amount (either for all or one of the payees), and only payable on or within a certain date.

If all the conditions/restrictions are met, as determined at step 208, the payment provider processes the payment request at step 216. Processing may include debiting the restricted use account the appropriate amount (which may include any service/processing fees) and crediting an account of the payee the requested amount. A notification may be sent to the user and/or the payee of a successful payment.

Returning back to step 208, if the conditions for withdrawing the requested funds are not met, the payment provider determines, at step 210, any conditions for the user to authorize the payment request. If there are no such conditions, the payment request is denied, and the user and/or the potential payee may be notified.

However, if there are certain conditions that will allow the user to approve the payment request, the payment provider proceeds with the authorization process at step 212. The process is dependent on the conditions for authorization. For example, the payment provider may simply text a confirmation request to the user on the user's mobile phone for a payment request that is slightly over an approved amount for the payee. Another condition may require the payment provider to call the user to obtain authorization by asking the user to answer one or more security questions and/or communicate a password or other information. Yet another condition may require to the user access the user's account with the payment provider and enter certain requested information.

At step 214, a determination is made whether the payment request can be approved. The payment provider may determine if the user provided the proper or expected response to the authorization request. For example, the request may be denied if the user does not respond, responds incorrectly, does not respond within a specified time frame, etc. If the request is not approved, the user may be notified by the payment provider. This notification may indicate a possible compromise of the user's account, and the payment provider may then take necessary steps to ensure the security of the user's account(s) with the payment provider.

If the request is approved, e.g., when the user responds with a correct answer or answers, password, code, credentials, etc., through text, voice, email, or other means, the payment may be processed at step 216. This may include debiting the user's restricted use account by the requested amount (plus any additional charges or fees) and crediting an account of the payee with an appropriate amount (such as with the amount requested at step 202). Once the payment is processed, the user and/or the payee may be notified of a successful payment, such as by email, text, voice, or mail.

Therefore, using the above, a user can ensure that important payments are made from a secure account, separate from a main account or accounts of the user with a payment provider. Even if the main account(s) are compromised, the secure or restricted use account remains protected and can be used to continue making these important and/or recurring payments. The user can customize restrictions for the account and revise at any time using a rules-based system to control both debiting and crediting of the account. This flexibility allows the account to be changed as payment conditions change, such as refinancing of a mortgage, closing a bank/credit card account, lowering payments due to a decreased cash availability, raising payments due to a cash surplus, etc.

In one embodiment, the secure account is not a separate account but is a portion of the main account. In this embodiment, the user may set rules on what portions or funds of the main account are restricted. For example, direct deposit funds may all be secured funds, subject to the various restrictions described above. Alternatively, a portion of the direct deposit funds may be subject to restricted use, while the remaining amount is for general or conventional use. The payment provider is thus able to manage secure and unsecure funds based on where the funds came from, e.g., direct deposit.

In another embodiment, the payment provider may determine, dynamically, whether more or less funds will be needed in a secure account or secure portion. This can be based on prior payments made from the secure account (as used herein, “account” also can refer to “portion” of a main account and need not be a separate account). For example, the payment provider may see that the larger payments are made during the winter months for a gas utility. In that case, the payment provider may suggest, through a notification to the user, that a larger amount be available during the winter months than in the non-winter months, with the larger amount depending on previous payments to the gas utility. This change may be automatically done by the payment provider or require confirmation from the user after notification. The user may also modify the suggested amount as desired.

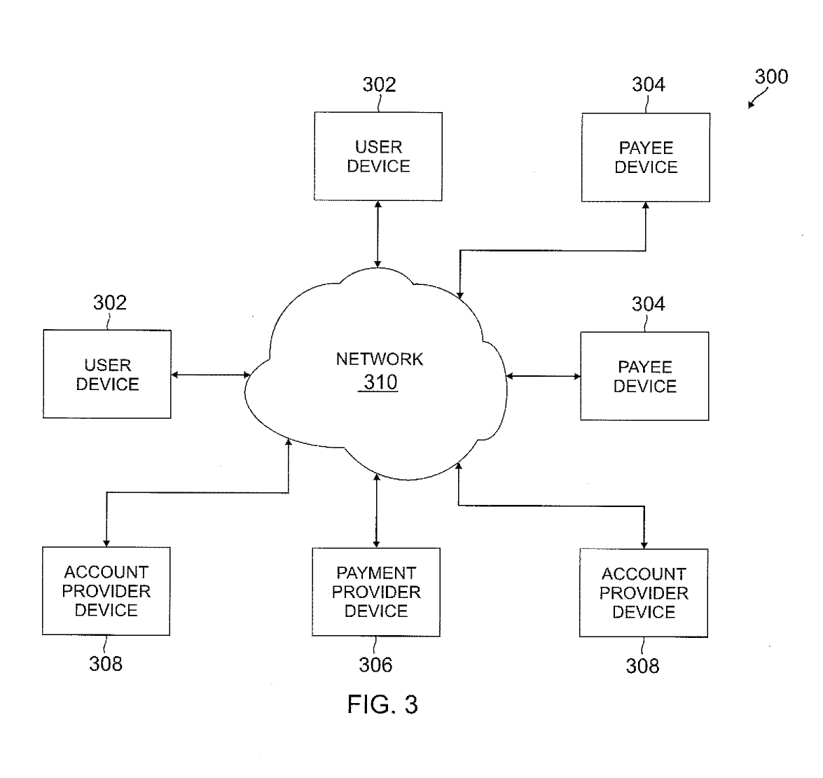

FIG. 3 is a block diagram of a networked system 300 used in the payment system described above according to one embodiment. Networked system 300 includes a plurality of user devices 302, a plurality of payee (e.g., bank, credit card company, landlord, building owner, utility company, service company, and the like) devices 304, a payment provider device 306, and a plurality of account holder devices 308 in communication over a network 310. Payee devices 304 may be associated and/or operated by the payees discussed above. Payment provider device 306 may be operated by a payment provider such as, for example, PayPal Inc. of San Jose, Calif. Account provider devices 308 may be operated by the account providers, for example, credit card account providers, bank account providers, savings account providers, and a variety of other account providers known in the art. Account providers may be used as funding sources for the user's account with the payment provider, where there may be restrictions as to which account providers may have access to the user's secure or restricted use account.

User devices 302, payee devices 304, payment provider device 306, and account provider devices 308 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of system 300, and/or accessible over network 310.

Network 310 may be implemented as a single network or a combination of multiple networks. For example, in various embodiments, network 310 may include the Internet and/or one or more intranets, landline networks, wireless networks, and/or other appropriate types of networks.

User device 302 may be implemented using any appropriate combination of hardware and/or software configured for wired and/or wireless communication over network 310. For example, in one embodiment, user device 302 may be implemented as a personal computer of a user in communication with the Internet. In other embodiments, user device 302 may be a smart phone, personal digital assistant (PDA), laptop computer, tablet, and/or other types of computing devices.

User device 302 may include one or more browser applications which may be used, for example, to provide a convenient interface to permit the payer to browse information available over network 310. For example, in one embodiment, the browser application may be implemented as a web browser configured to view information available over the Internet.

User device 302 may also include one or more toolbar applications which may be used, for example, to provide user-side processing for performing desired tasks in response to operations selected by the user. In one embodiment, the toolbar application may display a user interface in connection with the browser application, which allows the user to set up and revise, as needed, restrictions of the secure account.

User device 302 may further include other applications as may be desired in particular embodiments to provide desired features to user device 302. In particular, the other applications may include a payment application for payments assisted by a payment provider through payment provider device 306. The other applications may also include security applications for implementing user-side security features, programmatic user applications for interfacing with appropriate application programming interfaces (APIs) over network 310, or other types of applications. Email and/or text applications may also be included, which allow the user to send and receive emails and/or text messages through network 310. User device 302 includes one or more user and/or device identifiers which may be implemented, for example, as operating system registry entries, cookies associated with the browser application, identifiers associated with hardware of user device 302, or other appropriate identifiers, such as a phone number. In one embodiment, the user identifier may be used by payment provider device 306 and/or account provider device 308 to associate the user with a particular account.

Payee device 304 may be maintained, for example, by a service provider offering various services and/or products in exchange for payment to be received conventionally or over network 310, such as described herein. In this regard, payee device 304 may include a database identifying available services which may be made available for viewing, setup, and purchase by the user.

Payee device 304 also includes a checkout application which may be configured to facilitate the purchase by the user of services. The checkout application may be configured to accept payment information from the user through user device 302, the account provider through account provider device 308, and/or from the payment provider through payment provider device 306 over network 310.

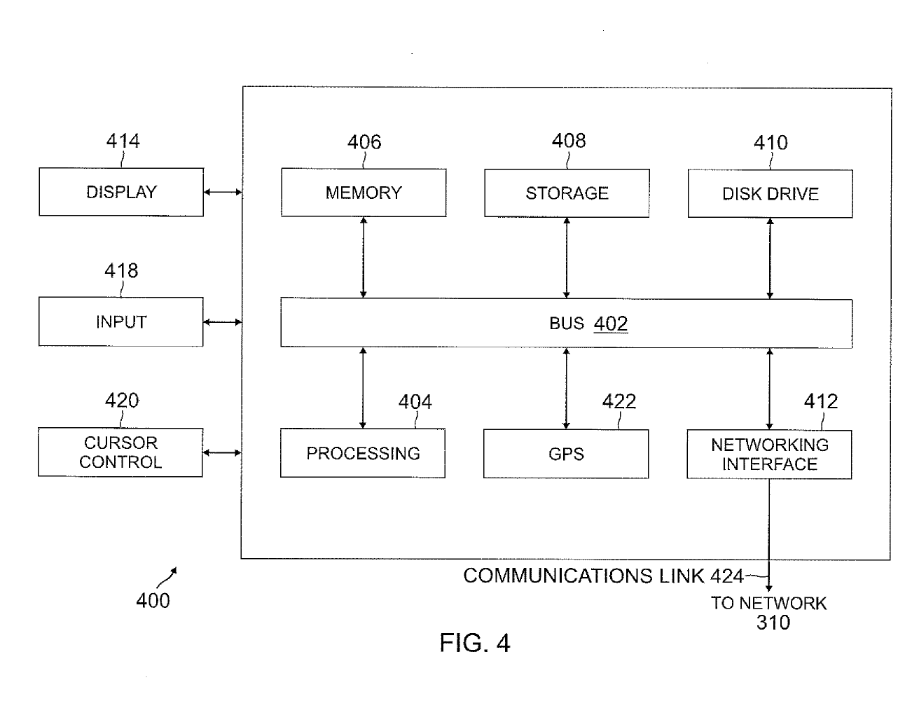

FIG. 4 is a block diagram of a computer system 400 suitable for implementing, for example, user device 302, payer device 400, payee devices 304, payment provider device 306, and/or account provider devices 308, is illustrated. It should be appreciated that other devices utilized by user or payer, payees, payment providers, and account providers in the payment system discussed above may be implemented as computer system 400 in a manner as follows.

In accordance with various embodiments of the present disclosure, computer system 400, such as a computer and/or a network server, includes a bus 402 or other communication mechanism for communicating information, which interconnects subsystems and components, such as a processing component 404 (e.g., processor, micro-controller, digital signal processor (DSP), etc.), a system memory component 406 (e.g., RAM), a static storage component 408 (e.g., ROM), a disk drive component 410 (e.g., magnetic or optical), a network interface component 412 (e.g., modem or Ethernet card), a display component 414 (e.g., CRT or LCD), an input component 418 (e.g., keyboard, keypad, or virtual keyboard), a cursor control component 420 (e.g., mouse, pointer, or trackball), and/or a location determination component 422 (e.g., a Global Positioning System (GPS) device as illustrated, a cell tower triangulation device, and/or a variety of other location determination devices known in the art). In one implementation, disk drive component 410 may comprise a database having one or more disk drive components.

In accordance with embodiments of the present disclosure, computer system 400 performs specific operations by processor 404 executing one or more sequences of instructions contained in memory component 406, such as described herein with respect to the user device, the payee device(s), the payment provider device, and/or the account provider device(s). Such instructions may be read into system memory component 406 from another computer readable medium, such as static storage component 408 or disk drive component 410. In other embodiments, hard-wired circuitry may be used in place of or in combination with software instructions to implement the present disclosure.

Logic may be encoded in a computer readable medium, which may refer to any medium that participates in providing instructions to processor 404 for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component 410, volatile media includes dynamic memory, such as system memory component 406, and transmission media includes coaxial cables, copper wire, and fiber optics, including wires that comprise bus 402. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by computer system 400. In various other embodiments of the present disclosure, a plurality of computer systems 400 coupled by a communication link 424 to network 310 (e.g., such as a LAN, WLAN, PTSN, and/or various other wired or wireless networks, including telecommunications, mobile, and cellular phone networks) may perform instruction sequences to practice the present disclosure in coordination with one another.

Computer system 400 may transmit and receive messages, data, information and instructions, including one or more programs (i.e., application code) through communication link 424 and network interface component 412. Network interface component 412 may include an antenna, either separate or integrated, to enable transmission and reception via communication link 424. Received program code may be executed by processor 404 as received and/or stored in disk drive component 410 or some other non-volatile storage component for execution.

FIG. 5 shows a user device/payment provider device/account provider device 500 according to one embodiment. In an embodiment, device 500 may be user device 302, payment provider device 306, and/or account holder device 308. Device 500 includes a communication engine 502 that is coupled to network 310 and to an automatic payment engine 504 that is coupled to a payer database 506. Communication engine 502 may be software or instructions stored on a computer-readable medium that allows device 500 to send and receive information over network 310. Automatic payment engine 504 may be software or instructions stored on a computer-readable medium that is operable to receive payment instructions (automatic or requiring a confirmation), payment locations, and payment details and associate them with user accounts in database 506, receive payment locations to determine whether the user device is in a payment location associated with a payment instruction, send payment requests, and provide any of the other functionality that is discussed above. While database 506 has been illustrated as located in device 500, one of skill in the art will recognize that it may be connected to automatic payment engine 504 through a network without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on payees and payers; however, a payer or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

1. A method, comprising:
receiving, electronically by a processor of a payment provider from a payee, a request for withdrawal of funds from an account of a user with the payment provider;
determining, by the processor, whether the request can be paid from a secure portion of the account or an unsecured portion of the account, wherein the secure portion is based, at least in part, on how existing funds arrived into the secure portion and wherein the user can fund both the secure portion and the unsecured portion of the account with funds for use and withdrawal;
determining whether one or more conditions for the secure portion exist based on the request, wherein the one or more conditions are determined by the user and must be met before funds from the secure account can be debited without user approval;
determining, by the processor, whether the one or more conditions are met for the request if the one or more conditions exist;
processing the request for withdrawal if all of the one or more conditions are met for the request; and
requesting the user to authorize the request if at least one of the one or more conditions are not met for the request.

2. The method of claim 1, wherein at least one of the conditions is a specification of an authorized payee.

3. The method of claim 1, wherein the secure portion is a separate account from a user second account with the payment provider.

4. The method of claim 1, wherein the one or more the conditions comprises a withdrawal amount limit, a time limit, or a withdrawal number limit.

5. The method of claim 1, wherein the requesting comprises requiring a verbal authorization.

6. The method of claim 1, further comprising notifying the user and/or the payee of a successful payment.

7. The method of claim 1, further comprising receiving the one or more conditions from the user through a user computing device.

8. The method of claim 1, further comprising:
receiving, electronically by the processor, a request for deposit of funds to the account;
determining, by the processor, whether one or more second conditions for the secure portion exist based on the request for deposit, wherein the one or more second conditions are determined by the user and must be met before funds to the secure portion can be credited;
determining, by the processor, whether the one or more second conditions are met for the request for deposit if the one or more second conditions exist; and
processing the request for deposit if all of the one or more second conditions are met for the request for deposit.

9. The method of claim 8, wherein the one or more second conditions comprise a requirement that the deposit be a direct deposit transaction.

10. An apparatus comprising a non-transitory, tangible computer readable storage medium storing a computer program, wherein the computer program contains instructions that when executed, perform:
receiving, by a payment provider from a payee, a request for withdrawal of funds from an account of a user with the payment provider;
determining whether the request can be paid from a secure portion of the account or an unsecured portion of the account, wherein the secure portion is based, at least in part, on how existing funds arrived into the secure portion and wherein the user can fund both the secure portion and the unsecured portion of the account with funds for use and withdrawal;
determining whether one or more conditions for the secure portion exist based on the request, wherein the one or more conditions are determined by the user and must be met before funds from the secure account can be debited without user approval;
determining whether the one or more conditions are met for the request if the one or more conditions exist;
processing the request for withdrawal if all of the one or more conditions are met for the request; and
requesting the user to authorize the request if at least one of the one or more conditions are not met for the request,

11. The apparatus of claim 10, wherein at least one of the conditions is a specification of an authorized payee.

12. The apparatus of claim 10, wherein the secure portion is a separate account from a user second account with the payment provider.

13. The apparatus of claim 10, wherein the one or more the conditions comprises a withdrawal amount limit, a time limit, or a withdrawal number limit.

14. The apparatus of claim 10, wherein the requesting comprises requiring a verbal authorization.

15. The apparatus of claim 10, wherein the computer program comprises further instructions that when executed, perform notifying the user and/or the payee of a successful payment.

16. The apparatus of claim 10, wherein the computer program comprises further instructions that when executed, perform:
receiving a request for deposit of funds to the account;
determining whether one or more second conditions for the secure portion exist based on the request for deposit, wherein the one or more second conditions are determined by the user and must be met before funds to the secure portion can be credited;
determining whether the one or more second conditions are met for the request for deposit if the one or more second conditions exist; and
processing the request for deposit if all of the one or more second conditions are met for the request for deposit.

17. The apparatus of claim 16, wherein the one or more second conditions comprise a requirement that the deposit be a direct deposit transaction.

18. A system, comprising:
a computer storage storing one or more user-determined conditions that must be met before funds from a secure portion of an account of a user can be debited without user approval;
a processor that is operable to:
receive, by a payment provider from a payee, a request for withdrawal of funds from the account of a user with the payment provider;
determine whether the request can be paid from the secure portion of the account or an unsecured portion of the account, wherein the secure portion is based, at least in part, on how existing funds arrived into the secure portion and wherein the user can fund both the secure portion and the unsecured portion of the account with funds for use and withdrawal;
determine whether the one or more user-determined conditions for the secure portion exist based on the request;
determine whether the one or more user-determined conditions are met for the request if the one or more user-determined conditions exist;
process the request for withdrawal without user approval if all of the one or more user-determined conditions are met for the request; and
request the user to authorize the request if at least one of the one or more user-determined conditions are not met for the request.

19. The system of claim 18, wherein the secure portion is a separate account from a user second account with the payment provider.

20. The system of claim 18, wherein to authorize requires a verbal authorization.
